(19) United States
(12) Patent Application Publication
(10) Pub. No.: US 2025/0227292 A1
(43) Pub. Date: Jul. 10, 2025

(54) CHROMA INTRA PREDICTION MODES

(71) Applicant: Alibaba (China) Co., Ltd., Hangzhou (CN)

(72) Inventors: Xinwei Li, Beijing (CN); Ru-ling Liao, Sunnyvale, CA (US); Jie Chen, Beijing (CN); Yan Ye, San Diego, CA (US)

(21) Appl. No.: 19/008,521

(22) Filed: Jan. 2, 2025

Related U.S. Application Data
(60) Provisional application No. 63/619,297, filed on Jan. 9, 2024.
(60) Provisional application No. 63/569,567, filed on Mar. 25, 2024.

(51) Int. Cl. H04N 19/593; H04N 19/105; H04N 19/176; H04N 19/186

(52) U.S. Cl. CPC H04N 19/593; H04N 19/105; H04N 19/176; H04N 19/186

(57) ABSTRACT

Methods and systems implement fusion of intra TMP mode with other intra prediction modes that utilize adjacent samples, to improve prediction accuracy. A VVC-standard encoder and a VVC-standard decoder can configure one or more processors of a computing system to apply non-CCP modes on the template of the collocated luma block, and reorder non-CCP modes based on template matching cost; additionally reorder angular modes, such as a subset of efficient angular modes based on the template of the collocated luma block; prune non-CCP modes from the ordered list based on similarity; move a non-CCP mode of the reordered ordered list based on template matching cost difference relative to a predecessor; copy and reorder the ordered list of non-CCP modes once for each respective distinctly signaled chroma fusion mode; fuse a chroma DBV mode with a CCP mode; and select a least-cost reordered block vector for chroma DBV mode.

### RELATED APPLICATIONS

The present U.S. Non-provisional patent application claims the priority benefit of a first prior-filed U.S. Provisional patent application having the title “IMPROVEMENTS TO CHROMA INTRA PREDICTION MODES FOR MOTION PREDICTION,” Ser. No. 63/619,297 filed Jan. 9, 2024, and U.S. Provisional patent application having the title “CHROMA INTRA PREDICTION MODES FOR MOTION PREDICTION,” Ser. No. 63/569,567 filed Mar. 25, 2024. The entire contents of the identified earlier-filed U.S. Provisional patent applications are hereby incorporated by reference into the present patent application.

### BACKGROUND

In 2020, the Joint Video Experts Team (“JVET”) of the ITU-T Video Coding Expert Group (“ITU-T VCEG”) and the ISO/IEC Moving Picture Expert Group (“ISO/IEC MPEG”) published the final draft of the next-generation video codec specification, Versatile Video Coding (“VVC”). This specification further improves video coding performance over prior standards such as H.264/AVC (Advanced Video Coding) and H.265/HEVC (High Efficiency Video Coding). The JVET continues to propose additional techniques beyond the scope of the VVC standard itself, collected under the Enhanced Compression Model (“ECM”) name.

According to the VVC standard, an encoder and a decoder partition picture data into blocks, and perform motion prediction upon luma and chroma components of the blocks by selecting one among various intra prediction and inter prediction modes. The VVC standard implements a DM mode, wherein an intra prediction mode of a collocated luma block of a current chroma block determines a chroma intra mode.

Moreover, at time of writing, the latest draft of ECM (presented at the 36th meeting of the JVET in November 2024 as “Algorithm description of Enhanced Compression Model 15 (ECM 15)”) includes proposals to further implement chroma intra prediction modes. A chroma block can be predicted by a chroma intra prediction mode among planar mode, DC mode and the 65 angular modes, as well as cross-component prediction (“CCP”) modes and non-CCP modes.

There is a need to further improve the capabilities of chroma intra prediction over the functionality provided by the VVC standard and by ECM.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIGS. 1A and 1B illustrate example block diagrams of, respectively, an encoding process and a decoding process according to an example embodiment of the present disclosure.

FIG. 2 illustrates reconstructed values of four reference samples used in planar mode.

FIG. 3 illustrates 67 angular intra prediction modes provided by VVC.

FIG. 4 illustrates reference lines used for intra prediction according to multiple reference line (“MRL”) intra prediction provided by VVC.

FIG. 5 illustrates reference lines used for intra prediction according to multiple reference line (“MRL”) intra prediction provided by ECM.

FIGS. 6A and 6B illustrate examples of sub-partitions of luma intra-predicted blocks according to intra sub-partitions (“ISP”).

FIG. 7 illustrates generation of a prediction signal according to Matrix-based Intra Prediction (“MIP”) mode.

FIG. 8 illustrates a convolutional 7-tap filter implemented by a Convolutional Cross-Component Model (“CCCM”) mode.

FIGS. 9A and 9B illustrate a collocated luma block of a current chroma block according to DM mode.

FIGS. 10A, 10B, and 10C illustrate neighboring reconstructed Y, Cb and Cr samples according to an intra mode derivation (“DIMD”) chroma mode.

FIGS. 11A and 11B illustrate luma blocks in five locations of the collocated luma block according to chroma direct block vector (“chroma DBV”) mode.

FIGS. 12A and 12B illustrate a collocated luma block according to an example embodiment of non-cross-component prediction (“CCP”) mode reordering.

FIGS. 13A and 13B illustrate predicting the template of the current chroma block by its neighboring samples according to non-CCP modes.

FIG. 14 illustrates neighbouring chroma blocks from which the angular intra prediction modes can be added to the reordered non-CCP modes according to an example embodiment.

FIG. 15 illustrates non-adjacent chroma blocks from which the angular intra prediction modes can be added to the reordered non-CCP modes according to an example embodiment.

FIG. 16 illustrates copying and reordering an ordered list of non-CCP modes once for each respective distinctly signaled chroma fusion mode.

FIG. 17 illustrates an example system for implementing the processes and methods described herein for implementing chroma intra prediction modes.

### DETAILED DESCRIPTION

Systems and methods discussed herein are directed to implementing chroma intra prediction modes for motion prediction, and more specifically applying non-CCP modes on the template of the collocated luma block, and reordering non-CCP modes based on template cost; additionally reordering angular modes, such as a subset of efficient angular modes based on the template of the collocated luma block; fusing a chroma DBV mode with a CCP mode; and selecting a least-cost reordered block vector for chroma DBV mode.

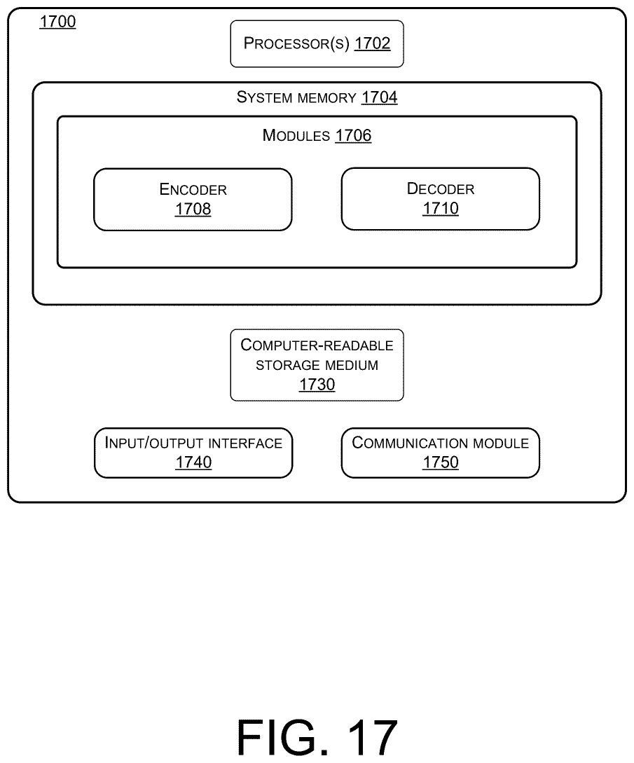

In accordance with the VVC video coding standard (the “VVC standard”) and motion prediction as described therein, a computing system includes at least one or more processors and a computer-readable storage medium communicatively coupled to the one or more processors. The computer-readable storage medium is a non-transient or non-transitory computer-readable storage medium, as defined subsequently with reference to FIG. 17, storing computer-readable instructions. At least some computer-readable instructions stored on a computer-readable storage medium are executable by one or more processors of a computing system to configure the one or more processors to perform associated operations of the computer-readable instructions, including at least operations of an encoder as described by the VVC standard, and operations of a decoder as described by the VVC standard. Some of these encoder operations and decoder operations according to the VVC standard are subsequently described in further detail, though these subsequent descriptions should not be understood as exhaustive of encoder operations and decoder operations according to the VVC standard. Subsequently, a “VVC-standard encoder” and a “VVC-standard decoder” shall describe the respective computer-readable instructions stored on a computer-readable storage medium which configure one or more processors to perform these respective operations (which can be called, by way of example, “reference implementations” of an encoder or a decoder).

Moreover, according to example embodiments of the present disclosure, a VVC-standard encoder and a VVC-standard decoder further include computer-readable instructions stored on a computer-readable storage medium which are executable by one or more processors of a computing system to configure the one or more processors to perform operations not specified by the VVC standard. A VVC-standard encoder should not be understood as limited to operations of a reference implementation of an encoder, but including further computer-readable instructions configuring one or more processors of a computing system to perform further operations as described herein. A VVC-standard decoder should not be understood as limited to operations of a reference implementation of a decoder, but including further computer-readable instructions configuring one or more processors of a computing system to perform further operations as described herein.

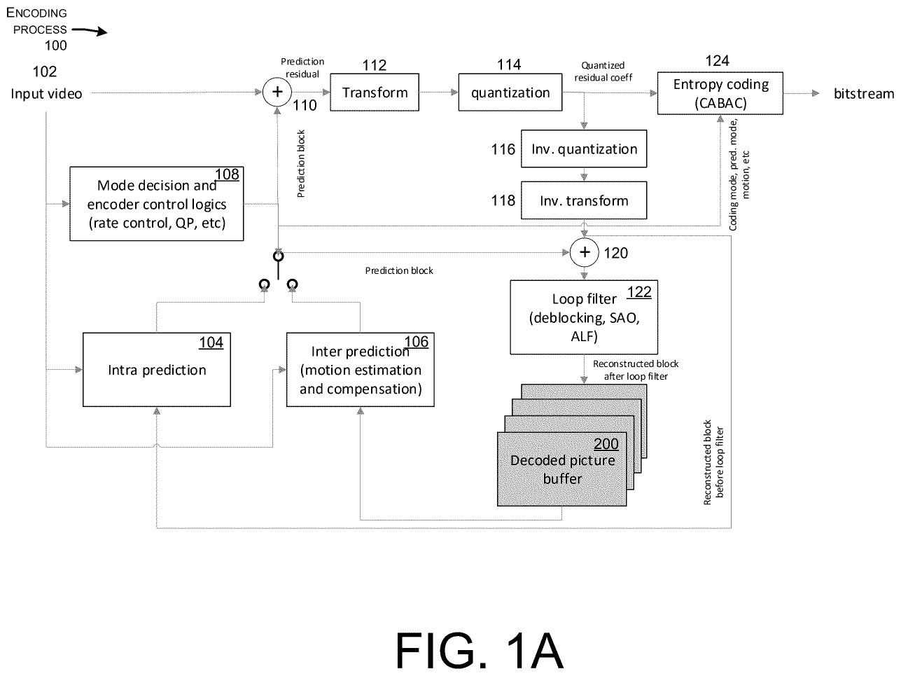

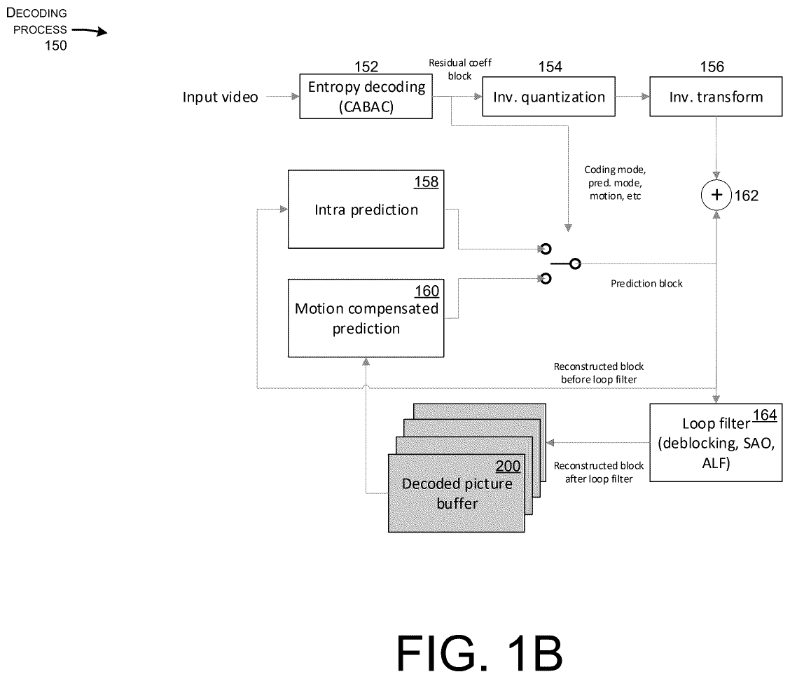

FIGS. 1A and 1B illustrate example block diagrams of, respectively, an encoding process 100 and a decoding process 150 according to an example embodiment of the present disclosure.

In an encoding process 100, a VVC-standard encoder configures one or more processors of a computing system to receive, as input, one or more input pictures from an image source 102. An input picture includes some number of pixels sampled by an image capture device, such as a photosensor array, and includes an uncompressed stream of multiple color channels (such as RGB color channels) storing color data at an original resolution of the picture, where each channel stores color data of each pixel of a picture using some number of bits. A VVC-standard encoder configures one or more processors of a computing system to store this uncompressed color data in a compressed format, wherein color data is stored at a lower resolution than the original resolution of the picture, encoded as a luma (“Y”) channel and two chroma (“U” and “V”) channels of lower resolution than the luma channel.

A VVC-standard encoder encodes a picture (a picture being encoded being called a “current picture,” as distinguished from any other picture received from an image source 102) by configuring one or more processors of a computing system to partition the original picture into units and subunits according to a partitioning structure. A VVC-standard encoder configures one or more processors of a computing system to subdivide a picture into macroblocks (“MBs”) each having dimensions of 16×16 pixels, which may be further subdivided into partitions. A VVC-standard encoder configures one or more processors of a computing system to subdivide a picture into coding tree units (“CTUs”), the luma and chroma components of which may be further subdivided into coding tree blocks (“CTBs”) which are further subdivided into coding units (“CUs”). Alternatively, a VVC-standard encoder configures one or more processors of a computing system subdivide a picture into units of N×N pixels, which may then be further subdivided into subunits. Each of these largest subdivided units of a picture may generally be referred to as a “block” for the purpose of this disclosure.

A CU is coded using one block of luma samples and two corresponding blocks of chroma samples, where pictures are not monochrome and are coded using one coding tree.

A VVC-standard encoder configures one or more processors of a computing system to subdivide a block into partitions having dimensions in multiples of 4×4 pixels. For example, a partition of a block may have dimensions of 8×4 pixels, 4×8 pixels, 8×8 pixels, 16×8 pixels, or 8×16 pixels.

By encoding color information of blocks of a picture and subdivisions thereof, rather than color information of pixels of a full-resolution original picture, a VVC-standard encoder configures one or more processors of a computing system to encode color information of a picture at a lower resolution than the input picture, storing the color information in fewer bits than the input picture.

Furthermore, a VVC-standard encoder encodes a picture by configuring one or more processors of a computing system to perform motion prediction upon blocks of a current picture. Motion prediction coding refers to storing image data of a block of a current picture (where the block of the original picture, before coding, is referred to as an “input block”) using motion information and prediction units (“PUs”), rather than pixel data, according to intra prediction 104 or inter prediction 106.

Motion information refers to data describing motion of a block structure of a picture or a unit or subunit thereof, such as motion vectors and references to blocks of a current picture or of a reference picture. PUs may refer to a unit or multiple subunits corresponding to a block structure among multiple block structures of a picture, such as an MB or a CTU, wherein blocks are partitioned based on the picture data and are coded according to the VVC standard. Motion information corresponding to a PU may describe motion prediction as encoded by a VVC-standard encoder as described herein.

A VVC-standard encoder configures one or more processors of a computing system to code motion prediction information over each block of a picture in a coding order among blocks, such as a raster scanning order wherein a first-decoded block is an uppermost and leftmost block of the picture. A block being encoded is called a “current block,” as distinguished from any other block of a same picture.

According to intra prediction 104, one or more processors of a computing system are configured to encode a block by references to motion information and PUs of one or more other blocks of the same picture. According to intra prediction coding, one or more processors of a computing system perform an intra prediction 104 (also called spatial prediction) computation by coding motion information of the current block based on spatially neighboring samples from spatially neighboring blocks of the current block.

According to inter prediction 106, one or more processors of a computing system are configured to encode a block by references to motion information and PUs of one or more other pictures. One or more processors of a computing system are configured to store one or more previously coded and decoded pictures in a reference picture buffer for the purpose of inter prediction coding; these stored pictures are called reference pictures.

One or more processors are configured to perform an inter prediction 106 (also called temporal prediction or motion compensated prediction) computation by coding motion information of the current block based on samples from one or more reference pictures. Inter prediction may further be computed according to uni-prediction or bi-prediction: in uni-prediction, only one motion vector, pointing to one reference picture, is used to generate a prediction signal for the current block. In bi-prediction, two motion vectors, each pointing to a respective reference picture, are used to generate a prediction signal of the current block.

A VVC-standard encoder configures one or more processors of a computing system to code a CU to include reference indices to identify, for reference of a VVC-standard decoder, the prediction signal(s) of the current block. One or more processors of a computing system can code a CU to include an inter prediction indicator. An inter prediction indicator indicates list 0 prediction in reference to a first reference picture list referred to as list 0, list 1 prediction in reference to a second reference picture list referred to as list 1, or bi-prediction in reference to both reference picture lists referred to as, respectively, list 0 and list 1.

In the cases of the inter prediction indicator indicating list 0 prediction or list 1 prediction, one or more processors of a computing system are configured to code a CU including a reference index referring to a reference picture of the reference picture buffer referenced by list 0 or by list 1, respectively. In the case of the inter prediction indicator indicating bi-prediction, one or more processors of a computing system are configured to code a CU including a first reference index referring to a first reference picture of the reference picture buffer referenced by list 0, and a second reference index referring to a second reference picture of the reference picture referenced by list 1.

A VVC-standard encoder configures one or more processors of a computing system to code each current block of a picture individually, outputting a prediction block for each. According to the VVC standard, a CTU can be as large as 128×128 luma samples (plus the corresponding chroma samples, depending on the chroma format). A CTU may be further partitioned into CUs according to a quad-tree, binary tree, or ternary tree. One or more processors of a computing system are configured to ultimately record coding parameter sets such as coding mode (intra mode or inter mode), motion information (reference index, motion vectors, etc.) for inter-coded blocks, and quantized residual coefficients, at syntax structures of leaf nodes of the partitioning structure.

After a prediction block is output, a VVC-standard encoder configures one or more processors of a computing system to send coding parameter sets such as coding mode (i.e., intra or inter prediction), a mode of intra prediction or a mode of inter prediction, and motion information to an entropy coder 124 (as described subsequently).

The VVC standard provides semantics for recording coding parameter sets for a CU. For example, with regard to the above-mentioned coding parameter sets, pred_mode_flag for a CU is set to 0 for an inter-coded block, and is set to 1 for an intra-coded block; general_merge_flag for a CU is set to indicate whether merge mode is used in inter prediction of the CU; inter_affine_flag and cu_affine_type_flag for a CU are set to indicate whether affine motion compensation is used in inter prediction of the CU; mvp_10_flag and mvp_1_flag are set to indicate a motion vector index in list 0 or in list 1, respectively; and ref_idx_10 and ref_idx_11 are set to indicate a reference picture index in list 0 or in list 1, respectively. It should be understood that the VVC standard includes semantics for recording various other information, flags, and options which are beyond the scope of the present disclosure.

A VVC-standard encoder further implements one or more mode decision and encoder control settings 108, including rate control settings. One or more processors of a computing system are configured to perform mode decision by, after intra or inter prediction, selecting an optimized prediction mode for the current block, based on the rate-distortion optimization method.

A rate control setting configures one or more processors of a computing system to assign different quantization parameters (“QPs”) to different pictures. Magnitude of a QP determines a scale over which picture information is quantized during encoding by one or more processors (as shall be subsequently described), and thus determines an extent to which the encoding process 100 discards picture information (due to information falling between steps of the scale) from MBs of the sequence during coding.

A VVC-standard encoder further implements a subtractor 110. One or more processors of a computing system are configured to perform a subtraction operation by computing a difference between an input block and a prediction block. Based on the optimized prediction mode, the prediction block is subtracted from the input block. The difference between the input block and the prediction block is called prediction residual, or “residual” for brevity.

Based on a prediction residual, a VVC-standard encoder further implements a transform 112. One or more processors of a computing system are configured to perform a transform operation on the residual by a matrix arithmetic operation to compute an array of coefficients (which can be referred to as “residual coefficients,” “transform coefficients,” and the like), thereby encoding a current block as a transform block (“TB”). Transform coefficients may refer to coefficients representing one of several spatial transformations, such as a diagonal flip, a vertical flip, or a rotation, which may be applied to a sub-block.

It should be understood that a coefficient can be stored as two components, an absolute value and a sign, as shall be described in further detail subsequently.

Sub-blocks of CUs, such as PUs and TBs, can be arranged in any combination of sub-block dimensions as described above. A VVC-standard encoder configures one or more processors of a computing system to subdivide a CU into a residual quadtree (“RQT”), a hierarchical structure of TBs. The RQT provides an order for motion prediction and residual coding over sub-blocks of each level and recursively down each level of the RQT.

A VVC-standard encoder further implements a quantization 114. One or more processors of a computing system are configured to perform a quantization operation on the residual coefficients by a matrix arithmetic operation, based on a quantization matrix and the QP as assigned above. Residual coefficients falling within an interval are kept, and residual coefficients falling outside the interval step are discarded.

A VVC-standard encoder further implements an inverse quantization 116 and an inverse transform 118. One or more processors of a computing system are configured to perform an inverse quantization operation and an inverse transform operation on the quantized residual coefficients, by matrix arithmetic operations which are the inverse of the quantization operation and transform operation as described above. The inverse quantization operation and the inverse transform operation yield a reconstructed residual.

A VVC-standard encoder further implements an adder 120. One or more processors of a computing system are configured to perform an addition operation by adding a prediction block and a reconstructed residual, outputting a reconstructed block.

A VVC-standard encoder further implements a loop filter 122. One or more processors of a computing system are configured to apply a loop filter, such as a deblocking filter, a sample adaptive offset (“SAO”) filter, and adaptive loop filter (“ALF”) to a reconstructed block, outputting a filtered reconstructed block.

A VVC-standard encoder further configures one or more processors of a computing system to output a filtered reconstructed block to a decoded picture buffer (“DPB”) 200. A DPB 200 stores reconstructed pictures which are used by one or more processors of a computing system as reference pictures in coding pictures other than the current picture, as described above with reference to inter prediction.

A VVC-standard encoder further implements an entropy coder 124. One or more processors of a computing system are configured to perform entropy coding, wherein, according to the Context-Sensitive Binary Arithmetic Codec (“CABAC”), symbols making up quantized residual coefficients are coded by mappings to binary strings (subsequently “bins”), which can be transmitted in an output bitstream at a compressed bitrate. The symbols of the quantized residual coefficients which are coded include absolute values of the residual coefficients (these absolute values being subsequently referred to as “residual coefficient levels”).

Thus, the entropy coder configures one or more processors of a computing system to code residual coefficient levels of a block; bypass coding of residual coefficient signs and record the residual coefficient signs with the coded block; record coding parameter sets such as coding mode, a mode of intra prediction or a mode of inter prediction, and motion information coded in syntax structures of a coded block (such as a picture parameter set (“PPS”) found in a picture header, as well as a sequence parameter set (“SPS”) found in a sequence of multiple pictures); and output the coded block.

A VVC-standard encoder configures one or more processors of a computing system to output a coded picture, made up of coded blocks from the entropy coder 124. The coded picture is output to a transmission buffer, where it is ultimately packed into a bitstream for output from the VVC-standard encoder. The bitstream is written by one or more processors of a computing system to a non-transient or non-transitory computer-readable storage medium of the computing system, for transmission.

In a decoding process 150, a VVC-standard decoder configures one or more processors of a computing system to receive, as input, one or more coded pictures from a bitstream.

A VVC-standard decoder implements an entropy decoder 152. One or more processors of a computing system are configured to perform entropy decoding, wherein, according to CABAC, bins are decoded by reversing the mappings of symbols to bins, thereby recovering the entropy-coded quantized residual coefficients. The entropy decoder 152 outputs the quantized residual coefficients, outputs the coding-bypassed residual coefficient signs, and also outputs the syntax structures such as a PPS and a SPS.

A VVC-standard decoder further implements an inverse quantization 154 and an inverse transform 156. One or more processors of a computing system are configured to perform an inverse quantization operation and an inverse transform operation on the decoded quantized residual coefficients, by matrix arithmetic operations which are the inverse of the quantization operation and transform operation as described above. The inverse quantization operation and the inverse transform operation yield a reconstructed residual.

Furthermore, based on coding parameter sets recorded in syntax structures such as PPS and a SPS by the entropy coder 124 (or, alternatively, received by out-of-band transmission or coded into the decoder), and a coding mode included in the coding parameter sets, the VVC-standard decoder determines whether to apply intra prediction 156 (i.e., spatial prediction) or to apply motion compensated prediction 158 (i.e., temporal prediction) to the reconstructed residual.

In the event that the coding parameter sets specify intra prediction, the VVC-standard decoder configures one or more processors of a computing system to perform intra prediction 158 using prediction information specified in the coding parameter sets. The intra prediction 158 thereby generates a prediction signal.

In the event that the coding parameter sets specify inter prediction, the VVC-standard decoder configures one or more processors of a computing system to perform motion compensated prediction 160 using a reference picture from a DPB 200. The motion compensated prediction 160 thereby generates a prediction signal.

A VVC-standard decoder further implements an adder 162. The adder 162 configures one or more processors of a computing system to perform an addition operation on the reconstructed residuals and the prediction signal, thereby outputting a reconstructed block.

A VVC-standard decoder further implements a loop filter 164. One or more processors of a computing system are configured to apply a loop filter, such as a deblocking filter, a SAO filter, and ALF to a reconstructed block, outputting a filtered reconstructed block.

A VVC-standard decoder further configures one or more processors of a computing system to output a filtered reconstructed block to the DPB 200. As described above, a DPB 200 stores reconstructed pictures which are used by one or more processors of a computing system as reference pictures in coding pictures other than the current picture, as described above with reference to motion compensated prediction.

A VVC-standard decoder further configures one or more processors of a computing system to output reconstructed pictures from the DPB to a user-viewable display of a computing system, such as a television display, a personal computing monitor, a smartphone display, or a tablet display.

Therefore, as illustrated by an encoding process 100 and a decoding process 150 as described above, a VVC-standard encoder and a VVC-standard decoder each implements motion prediction coding in accordance with the VVC specification. A VVC-standard encoder and a VVC-standard decoder each configures one or more processors of a computing system to generate a reconstructed picture based on a previous reconstructed picture of a DPB according to motion compensated prediction as described by the VVC standard, wherein the previous reconstructed picture serves as a reference picture in motion compensated prediction as described herein.

According to the VVC standard, coding trees are configured to provide separate block tree structures for the luma and chroma components of a picture. A CTU can include three CTBs, these in turn including one luma CTB (“Y”) and two chroma CTBs (“Cb” and “Cr”).

For P slices and B slices, luma and chroma CTBs of one CTU are configured to share a common coding tree structure. However, for I slices, the luma and chroma CTBs can be configured having separate block tree structures. Given a coding tree configured for separate block trees, a luma CTB is partitioned into CUs by a first coding tree structure, and chroma CTBs are partitioned into chroma CUs by a second coding tree structure.

In other words, while a CU of an I slice may contain a coding block of the luma component or coding blocks of two chroma components, a CU in a P or B slice contains coding blocks of all three color components (unless the video is monochrome).

According to the VVC standard, the luma component can be predicted by multiple intra prediction modes. These include planar mode, DC mode, angular intra prediction modes; Multiple Reference Line (“MRL”) prediction mode; Intra Sub-partition (“ISP”) mode; and Matrix-based Intra Prediction (“MIP”) mode. Furthermore, Enhanced Compression Model (“ECM”) extends some intra prediction modes (such as planar mode, MRL mode and IBC mode) and adds new intra prediction modes (such as DIMD mode, TIMD mode and intra TMP mode). These modes are described in further detail subsequently.

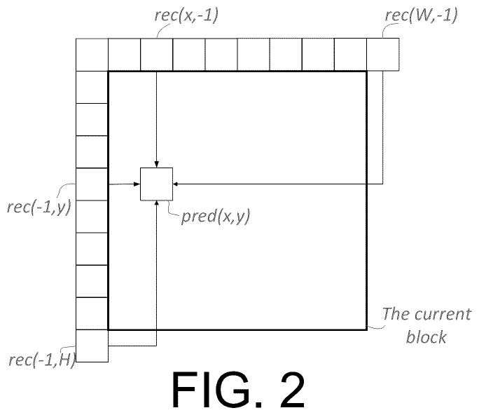

According to planar mode, predicted value of the current sample is obtained from reconstructed values of four reference samples: the left reference sample in the same row as the current sample, the above reference sample in the same column as the current sample, the reference sample on the bottom-left position adjacent to the current block and the reference sample on the top-right position adjacent to the current block. For example, using pred(x, y) to represent the predicted value of the current sample, using H to represent the height of the current block, and using W to represent the width of the current block, the reconstructed values of the four reference samples used in planar mode can be respectively represented as rec(−1,y), rec(x, −1), rec(−1, H) and rec(W, −1) as illustrated in FIG. 2, where (x,y) represents the coordinate positions of the current sample relative to the top-left position within the current block.

Planar mode generates the predicted value of the current sample according to Equations 1, 2, and 3 below. In Equation 1, an intermediate value predV(x,y) is obtained from rec(x, −1) and rec(−1, H); in Equation 2, another intermediate value predH(x,y) is obtained from rec(−1,y) and rec(W, −1); and the two intermediate values are used to generate the predicted value of the current sample according to Equation 3.

$$predV ( x , y ) = ( ( H - 1 - y ) * rec ( x , - 1 ) + ( y + 1 ) * rec ( - 1 , H ) ) << {log}_{2} W$$

$$predH ( x , y ) = ( ( W - 1 - x ) * rec ( - 1 , y ) + ( x + 1 ) * rec ( W , - 1 ) ) << {log}_{2} H$$

$$pred ( x , y ) = ( predV ( x , y ) + predH ( x , y ) + W * H ) >> ( {log}_{2} W + {log}_{2} H + 1 )$$

ECM provides two additional planar modes where only the horizontal interpolation or only the vertical interpolation are used to obtain the predicted samples for luma.

For planar horizontal mode, only the horizontal linear interpolation is performed based on the left reference sample and the top-right reference sample to predict the current sample by Equation 4 below:

$$pred ( x , y ) = ( ( W - 1 - x ) * rec ( - 1 , y ) + ( x + 1 ) * rec ( W , - 1 ) + ( W >> 1 ) ) >> {log}_{2} ( W )$$

For planar vertical mode, only the vertical linear interpolation is performed based on the above reference sample and the bottom-left reference sample to predict the current sample by Equation 5 below:

$$pred ( x , y ) = ( ( H - 1 - y ) * rec ( x , - 1 ) + ( y + 1 ) * rec ( - 1 , H ) + ( H >> 1 ) ) >> {log}_{2} ( H )$$

According to DC mode, an average value of the left and above reference samples to the current block is used for prediction generation. In HEVC, every intra-coded block has a square shape and the length of each of its side (i.e., left and above) is a power of 2. Thus, no division operations are required to calculate the average value. In contrast, according to VVC, blocks can have a rectangular shape that necessitates the use of a division operation per block in the general case. To avoid division operations for DC prediction, only the longer side is used to compute the average value for non-square blocks. For square blocks, reference samples from both left and above sides are used to compute the average value.

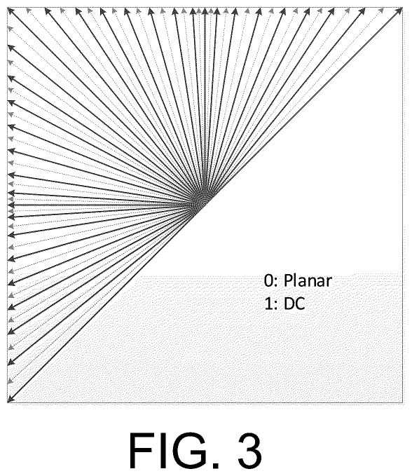

Angular intra prediction is a directional intra prediction method, which is extended from a prior implementation according to the HEVC standard. To capture the arbitrary edge directions presented in natural video, the VVC standard extends the number of angular intra prediction modes from 33 (as used in HEVC) to 65. The new angular intra prediction modes not in HEVC are depicted as broken lines in FIG. 3. The 65 angle modes can be represented as mode index 2 to mode index 66 from bottom left to top right.

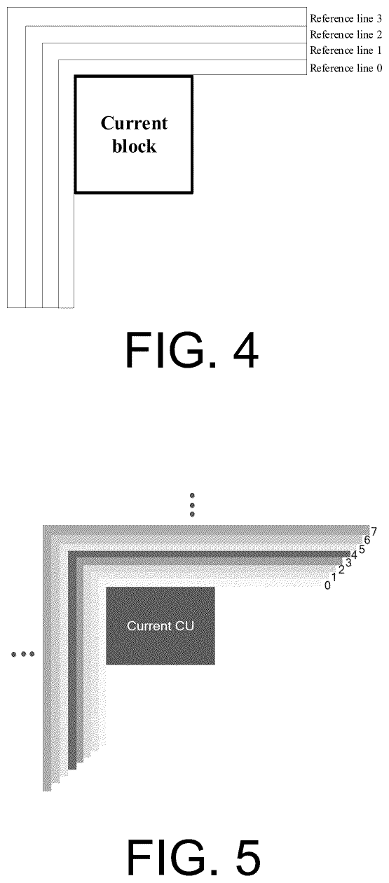

Multiple reference line (“MRL”) intra prediction uses more reference lines for intra prediction. In MRL, 2 additional lines (reference line 1 and reference line 3) can be used, as illustrated by FIG. 4. The index of selected reference line is signaled and used to generate intra prediction samples.

ECM extends the MRL list to include more reference lines for intra prediction. The extended reference line list consists of line indices {1, 3, 5, 7, 12}, as illustrated by FIG. 5. For template-based intra mode derivation (“TIMD”), instead of the full MRL candidate list, only the first two reference line candidates, i.e., {1, 3}, are used.

ECM further provides a template-based multiple reference line intra prediction (“TMRL”) mode, which combines reference line and prediction mode together and uses a template matching method to construct a list of candidate combinations. An index to the candidate combination list is coded to indicate which reference line and prediction mode is used in coding the current block. For non-TIMD parts, TMRL mode is used instead of MRL.

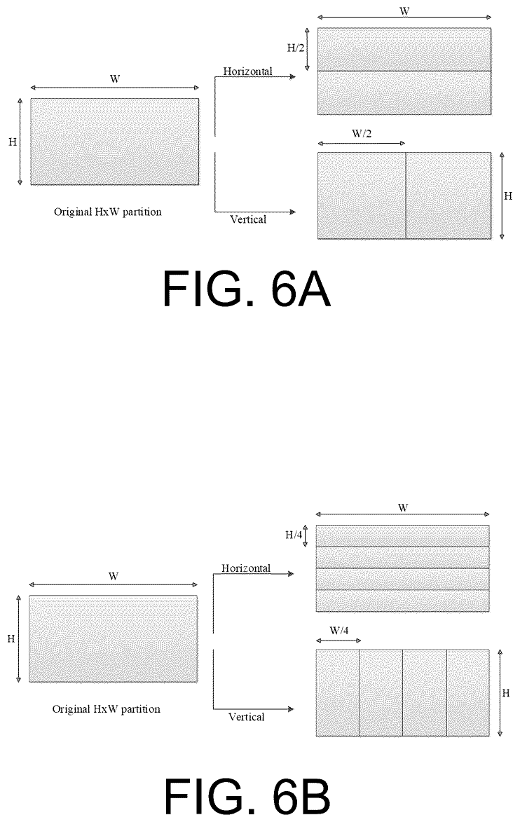

Intra sub-partitions (“ISP”) divides luma intra-predicted blocks vertically or horizontally into 2 or 4 sub-partitions depending on block size. FIGS. 6A and 6B illustrate examples of sub-partitions of luma intra-predicted blocks according to ISP. For each sub-partition, reconstructed samples are obtained by adding the residual signal to the prediction signal. Here, a residual signal is generated by processes such as entropy decoding, inverse quantization and inverse transform. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines.

In ISP mode, all 67 intra prediction modes (planar mode, DC mode and 65 angular intra prediction modes) are allowed. All sub-partitions in a block share the same intra prediction mode.

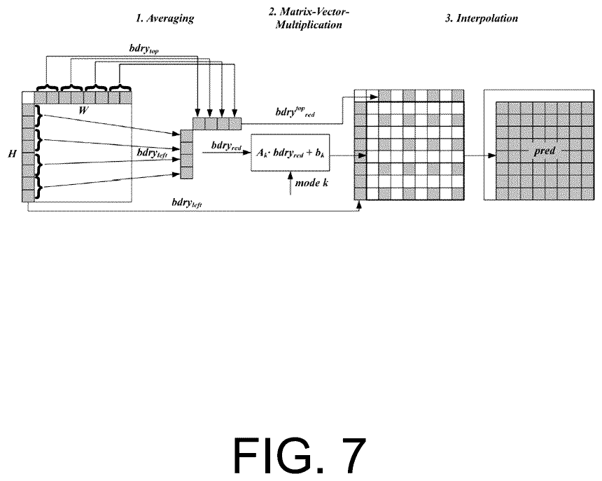

According to MIP, for predicting the samples of a block of width W and height H, one line of H reconstructed neighboring boundary samples left of the block and one line of W reconstructed neighboring boundary samples above the block are taken as input. The generation of the prediction signal is based on three steps: a down-sampling of the reference samples, a matrix vector multiplication, and an up-sampling of the result by linear interpolation as illustrated by FIG. 7.

Furthermore, intra block copy (“IBC”) mode is implemented as a block level coding mode. Herein, a VVC-standard encoder configures one or more processors of a computing system to perform block matching (“BM”) to find the optimal block vector (or motion vector) for each CU. A block vector indicates the displacement from the current block to a reference block, which is already reconstructed inside the current picture. The luma block vector of an IBC-coded CU is in integer precision. The chroma block vector rounds to integer precision as well.

ECM further provides that IBC is not limited to use on screen content materials, and can also be used on natural content materials (or camera-captured content materials). Furthermore, the option of block vector resolutions is extended to include quarter-pel resolution.

ECM provides a Reconstruction-Reordered IBC (“RR-IBC”) mode, allowed for IBC coded blocks. When RR-IBC is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block. Two flip methods, horizontal flip and vertical flip, are supported for RR-IBC coded blocks.

ECM further provides Bi-predictive IBC merge. In bi-predictive IBC merge, two BVs from the existing IBC merge candidate list are derived, utilizing two different indices, which are signaled.

ECM provides intra template matching prediction (“IntraTMP”), a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side. A block vector that indicates the displacement from the current block to the corresponding block is stored.

VVC supports block differential pulse coded modulation (“BDPCM”) for screen content coding. If BDPCM is used, the block is predicted using the regular horizontal or vertical intra prediction process with unfiltered reference samples. The residual is quantized and the difference between each quantized residual and its predictor, i.e., the previously coded residual of the horizontal or vertical (depending on the BDPCM prediction direction) neighbouring position, is coded.

ECM provides a decoder-side intra mode derivation (“DIMD”) mode. Up to five intra prediction modes among angular intra prediction modes are derived from the reconstructed neighbor samples, and those five predictors are combined with the planar mode predictor with the weights derived from a histogram of gradients.

ECM provides a template-based intra mode derivation (“TIMD”) mode. For each intra prediction mode in a list, the Sum of Transformed Absolute Difference (“SATD”) value between the prediction and reconstruction samples of a L-shaped template is calculated. A first two intra prediction modes with the minimum SATD value are selected as the TIMD modes. These two TIMD modes are fused with SATD based weights, and such weighted intra prediction is used to code the current CU.

According to the VVC standard, chroma components can be predicted by multiple intra prediction modes. These include Cross Component Linear Model (“CCLM”) mode, Direct Mode (“DM”), and four default intra prediction modes. Furthermore, ECM extends some intra prediction modes (such as CCLM mode) and adds new intra prediction modes (such as DIMD mode and chroma fusion mode). These modes are described in further detail subsequently.

According to the present disclosure, the luma block with the same position as the current chroma block can be denoted as the “collocated luma block.” For example, for 4:2:0 color format, for a W×H chroma block with position coordinate (i, j), the collocated luma block is a 2 W×2 H luma block at (2i, 2j).

According to the VVC standard, a relationship between the luma component and the chroma components is represented by a Cross Component Linear Model (“CCLM”). Equation 6 below predicts a chroma sample of a block from a collocated reconstructed luma sample by a linear model:

$${pred}_{C} ( i , j ) = α \cdot {rec}_{L}^{′} ( i , j ) + β$$

where pred_{C}(i,j) represents the predicted values of the chroma samples in the current block and rec_{L}′(i,j) represents the reconstructed values of the collocated luma samples of the same block which are down-sampled for the case of non-4:4:4 color format; and (i,j) is the coordinate of a sample in the block. The linear model is composed of the parameters α and β, whose values are derived based on reconstructed samples that are adjacent to the current block at both encoder and decoder side without explicit signaling.

Three CCLM modes, CCLM_LT, CCLM_L and CCLM_T, are specified in the VVC standard. These three modes differ with respect to the locations of the reconstructed adjacent samples that are used for linear model parameters (α and β) derivation. The above reconstructed adjacent samples are involved in the CCLM_T mode and the left reconstructed adjacent samples are involved in the CCLM_L mode. In the CCLM_LT mode, both above and left reconstructed adjacent samples are used.

Furthermore, ECM extends the VVC implementation of CCLM by introducing three multi-model CCLM (“MM-CCLM”) modes. The samples within a CU are divided into different groups and each group has a linear model for prediction. Dependent on the adjacent reconstructed samples used in model derivation, MM-CCLM also provides different modes: MMLM_LT, MMLM_L and MMLM_T. The difference among the three modes is the same as the difference among CCLM_LT, CCLM_L and CCLM_T modes: the locations of the reconstructed adjacent samples that are used for linear model parameters (α and β) derivation.

In each MM-CCLM mode, there can be more than one linear model relating luma and chroma in a block. First, the reconstructed adjacent samples are classified into two classes using a threshold which is the average of the values of the luma reconstructed adjacent samples. Then, each class is treated as an independent training set to derive a linear model. Subsequently, the reconstructed luma samples of the current block are also classified based on the same rule. Finally, the chroma samples are predicted by the reconstructed luma samples differently in different classes.

Furthermore, ECM provides a convolutional cross-component model (“CCCM”) applied to predict chroma samples from reconstructed luma samples in a similar fashion as the CCLM modes. As with CCLM, the reconstructed luma samples are down-sampled to match the lower resolution chroma grid when chroma sub-sampling is used. Similar to CCLM, top, left or top and left adjacent samples are used as templates for model derivation. Also, similarly to CCLM, CCCM provides a single model variant and a multi-model variant.

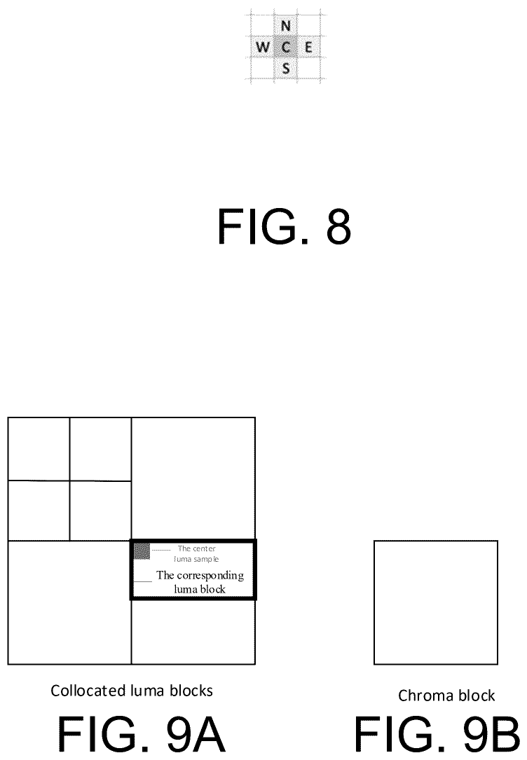

CCCM implements a convolutional 7-tap filter, composed of a cross-shaped 5-tap spatial component, a nonlinear term, and a bias term. The input to the spatial 5-tap component of the filter includes of a center (“C”) luma sample which is collocated with the chroma sample to be predicted and its above/north (“N”), below/south (“S”), left/west (“W”) and right/east (“E”) neighbors as illustrated by FIG. 8.

ECM further provides various variants of CCCM mode, including CCCM using non-downsampled luma samples (“NS-CCCM”), Block-vector guided CCCM (“BVG-CCCM”), Gradient and Location based convolutional cross-component model (“GL-CCCM”), and CCCM with Multiple Downsampling Filters (“MDF-CCCM”).

ECM further providers a Gradient Linear Model (“GLM”) method. Compared with CCLM, instead of down-sampling the reconstructed luma samples, GLM utilizes luma sample gradients to derive the linear model.

According to the present disclosure, any and all such modes (including CCLM mode, CCCM mode, GLM mode and variants thereof) which reduce the signal redundancy between difference components can be denoted as cross-component prediction (“CCP”) modes.

According to the VVC standard, a direct mode (DM mode) can be used to predict a chroma block. In applying DM mode, the intra prediction mode of a collocated luma block of a current chroma block determines the chroma intra mode as follows. If the collocated luma block uses the planar, DC or an angular intra prediction mode, the same mode is used to predict the current chroma block. If the collocated luma block is coded using IBC or Palette mode, the DC mode is used to predict the current chroma block. If the collocated luma block is coded using BDPCM mode, depending on the direction of the BDPCM, either the horizontal or the vertical intra prediction mode is used. If the collocated luma block uses MIP, then, if the chroma color format is 4:4:4 and the single partitioning tree is applied, the same MIP mode is applied for the chroma block and otherwise, the planar mode is applied.

For B slices and P slices, the collocated luma block represents the luma block at the same position as the current chroma block. For I slices, one chroma coding block may correspond to multiple luma coding blocks since the separate block partitioning structure for luma and chroma components is enabled. The collocated luma block represents the luma coding block containing the center position luma sample as illustrated by FIGS. 9A and 9B.

VVC provides that, when the CCLM modes and DM mode are not used, the other four default intra prediction modes are given by the list {planar mode, vertical mode, horizontal mode, DC mode} and can be used to predict a chroma block. In cases where the DM mode already belongs to that list, that is, the intra chroma prediction mode derived from the DM mode is the same as one of the four default intra prediction modes, then the default intra prediction mode in the list is replaced with an angular intra prediction mode with a mode index of 66.

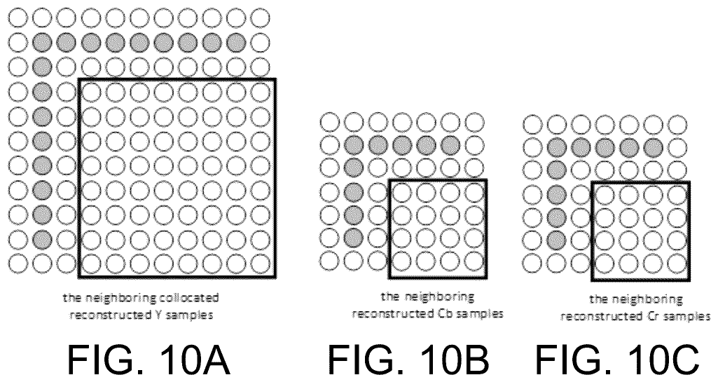

ECM provides prediction of a chroma block by a chroma DIMD mode. A chroma intra prediction mode among planar mode, DC mode and the 65 angular intra prediction modes can be derived based on the neighboring reconstructed Y, Cb and Cr samples in the second neighboring row and column as illustrated by FIGS. 10A, 10B, and 10C. Specifically, a horizontal gradient and a vertical gradient are calculated for each collocated reconstructed luma sample of the current chroma block, as well as the reconstructed Cb and Cr samples, to build a histogram of gradients. Then, the intra prediction mode with the largest histogram amplitude values is used for performing chroma intra prediction of the current chroma block.

When the intra prediction mode derived from the chroma DIMD mode is the same as the intra prediction mode derived from the DM mode, the intra prediction mode with the second largest histogram amplitude value is used as the chroma DIMD mode. A CU level flag is signaled to indicate whether the proposed chroma DIMD mode is applied.

The luma region of reconstructed samples used for computing the histogram of gradients for chroma DIMD mode is modified: for a W×H chroma block, to build the histogram of gradients associated to the collocated luma block, the pairs of a vertical gradient and a horizontal gradient are extracted from the second and third lines in this collocated luma block instead of the second neighboring row and column of the collocated luma block.

ECM provides that two chroma intra prediction signals can be fused together (subsequently referred to as “chroma fusion modes,” in addition to utilizing no chroma fusion (“no fusion”)). One of the two chroma intra prediction signals is predicted using one of the DM mode, chroma DIMD mode and the four default intra prediction modes (subsequently referred to as “non-CCP mode”). The other chroma intra prediction signal is predicted using cross-component prediction modes (a CCP mode). Two different methods are supported.

By the first method, the CCP mode can be either multi-model CCLM mode or multi-model CCCM mode, and the final predictor is derived as in Equation 7 below:

$${pred}_{C} ( i , j ) = ( w 0 \times pred 0 ( i , j ) + w 1 \times pred 1 ( i , j ) + ( 1 << ( shift - 1 ) ) ) >> shift$$

where pred0(i,j) is the predictor obtained by applying the non-CCP mode, pred1(i,j) is the predictor obtained by applying the CCP mode and pred_{C}(i,j) is the final predictor of the current chroma block. The two weights w0 and w1 are determined by the intra prediction mode of adjacent chroma blocks and shift is set equal to 2. Specifically, when the above and left adjacent blocks are both coded with CCP modes, {w0, w1}={1, 3}; when the above and left adjacent blocks are both coded with non-CCP modes, {w0, w1}={3, 1}; otherwise, {w0, w1}={2, 2}. Two template costs are calculated by fusing the non-CCP chroma prediction with MM-CCLM or MM-CCCM, respectively, and the one of the two CCP modes which provides a smaller template cost is utilized to derive pred1.

By the second method, the CCP mode can be either MMLM or CCLM mode, and the final predictor is derived as in Equation 8 below:

$${pred}_{C} ( i , j ) = {α}_{0} \times pred 0 ( i , j ) + {α}_{1} \times {rec}_{L}^{′} ( i , j ) + {α}_{2} \times β$$

where pred0(i,j) is the predictor obtained by applying the non-CCP mode, rec_{L}′(i,j) is the set of downsampled reconstructed luma samples at co-located positions and pred_{C}(i, j) is the final predictor of the current chroma block. β is a fixed value and is set equal to 512 for 10-bit color depth content. The three weights α₀, α₁, and α₂ are derived from the adjacent luma and chroma samples using the same derivation method as in CCCM.

ECM provides for signaling of: “no fusion”; the “first method” of chroma fusion as described above; the “second method” of chroma fusion as described above where the CCP mode is CCLM; and the “second method” of chroma fusion as described above where the CCP mode is MMLM, as four distinctly signaled chroma fusion modes.

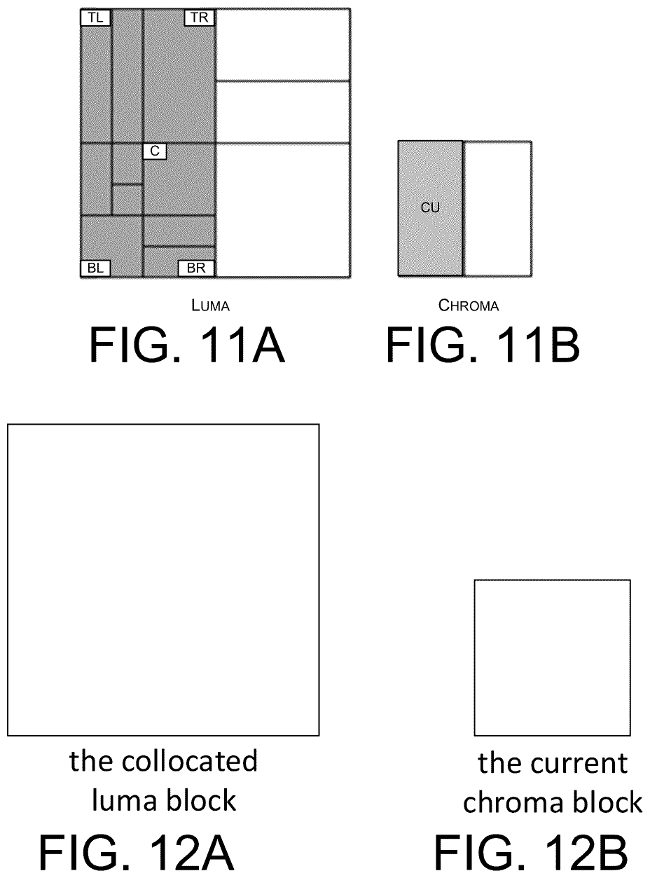

ECM provides that a chroma direct block vector (“chroma DBV”) mode can be used to predict a chroma block for a dual partitioning tree. If at least one of the luma blocks in five locations of the collocated luma block as shown in FIGS. 11A and 11B is coded with IBC or intraTMP mode and the block vector is available (i.e., encoded or decoded before the current coding block according to raster scanning order) for the current chroma block, its block vector is scaled and used as the block vector for the current chroma block. The block vector is selected in the following order: {C, TL, TR, BL, BR}, and the first block vector that is available for the current chroma block is selected. Then a template matching method is used to perform block vector scaling.

If the luma block that the block vector is selected from is coded with a RR-IBC mode, the flip type is inherited by the current chroma block, and the flip scheme of the RR-IBC is performed. That is, at the encoder side, the original block is flipped before residual calculation, while the prediction block is derived without flipping; at the decoder side, the reconstruction block is flipped back to restore the original block.

According to coding semantics for coding parameters provided by ECM, a first flag indicating whether one of the CCP modes is applied to a chroma block is signaled first. If the first flag indicating the CCP mode is not applied, one among multiple flags is signaled, where each of the multiple flags indicates one among multiple non-CCP modes participating in coding the chroma block; among the multiple non-CCP modes, the signaled non-CCP mode is applied. In one example, Table 1 below shows the signaled flags and each corresponding non-CCP mode. Then, a flag is signaled to indicate whether chroma fusion mode is applied.

| Signaled flags | Non-CCP mode |
|---|---|
| 0 | chroma DBV mode |
| 10 | DM mode |
| 110 | chroma DIMD mode |
| 11100 | default intra prediction mode 0 |
| 11101 | default intra prediction mode 1 |
| 11110 | default intra prediction mode 2 |
| 11111 | default intra prediction mode 3 |

According to another example, Table 2 below shows the signaled flags and each corresponding non-CCP mode participating in coding the chroma block when there is no available block vector from the collocated block, which means the chroma DBV mode is not participating in coding the chroma block.

| Signaled flags | Non-CCP mode |
|---|---|
| 0 | DM mode |
| 10 | chroma DIMD mode |
| 1100 | default intra prediction mode 0 |
| 1101 | default intra prediction mode 1 |
| 1110 | default intra prediction mode 2 |
| 1111 | default intra prediction mode 3 |

As described above, ECM provides that participating non-CCP modes can include chroma DBV mode, chroma DIMD mode, DM mode and four default intra prediction modes. A fixed signaling order is used to signal the flags indicating which participating non-CCP mode is selected: therefore, earliest-ordered modes are transmitted in a bitstream using fewer bits, and latest-ordered modes are transmitted in a bitstream using more bits. For a specific chroma block, if these modes can be sorted according to the probability of selecting these modes, the bit overhead can be effectively reduced. The template of the chroma block and the collocated luma block may have a similar texture to the current chroma block.

To save bit overhead for chroma, there are not as many intra prediction modes allowed as for luma. Allowing more modes may increase bit overhead. In general, enabling more angular intra prediction modes for a chroma block can improve the prediction accuracy. However, the greater the number of the angular intra prediction modes enabled for a chroma block, the greater the bit overhead required, so the overall BD-rate performance may not be better.

ECM provides that DM mode, chroma DIMD mode and the four default intra prediction modes each can be fused with a CCP mode. The chroma DBV mode is also a non-CCP mode, which cannot be fused with a CCP mode.

In chroma DBV mode, only one block vector can be used to predict the current chroma block, even if there are multiple block vectors from the collocated luma block is available to the current chroma block.

Therefore, example embodiments of the present disclosure provide applying non-CCP modes on the template of the collocated luma block, and reordering signaling order of non-CCP modes based on template cost; additionally reordering angular intra prediction modes, such as a subset of efficient angular intra prediction modes based on the template of the collocated luma block; fusion of a chroma DBV mode with a CCP mode; and selection of a least-cost reordered block vector for chroma DBV mode.

According to an example embodiment of non-CCP mode signaling order reordering, an ordered list is constructed listing non-CCP modes participating in coding a template of a collocated luma block of a current chroma block; and signaling order of any, some, or all of the non-CCP modes for a chroma block, including chroma DBV mode, DM mode, chroma DIMD mode and the four default intra prediction modes, is reordered. The non-CCP modes are used to predict the collocated luma block by its neighboring samples as illustrated by FIGS. 12A and 12B. Template cost function outputs, such as Sum of Absolute Difference (“SAD”) values, between the predicted values and the reconstructed values of the collocated luma block are calculated for each non-CCP mode. Signaling order of these non-CCP modes is reordered according to SAD value from small to large. Non-CCP modes from minimum SAD value to maximum SAD value are denoted as list[0] to list[6]. The non-CCP modes can be signaled according to Table 3 below, denoting signaling order as an ordered list; the ordered list is constructed with each non-CCP mode participating in reordering as an element of the ordered list, and elements of the ordered list are reordered to yield a reordered signaling order of non-CCP modes:

| Signaled flags | Non-CCP mode |
|---|---|
| 0 | list[0] |
| 10 | list[1] |
| 110 | list[2] |
| 11100 | list[3] |
| 11101 | list[4] |
| 11110 | list[5] |
| 11111 | list[6] |

In some embodiments, different signaled flags are used to indicate which non-CCP mode is selected. For example, a truncated unary code can be used to code the flags as shown in Table 4 below:

| Signaled flags | Non-CCP mode |
|---|---|
| 0 | list[0] |
| 10 | list[1] |
| 110 | list[2] |
| 1110 | list[3] |
| 11110 | list[4] |
| 111110 | list[5] |
| 111111 | list[6] |

In some embodiments, the template of the current chroma block is used to reorder the non-CCP modes.

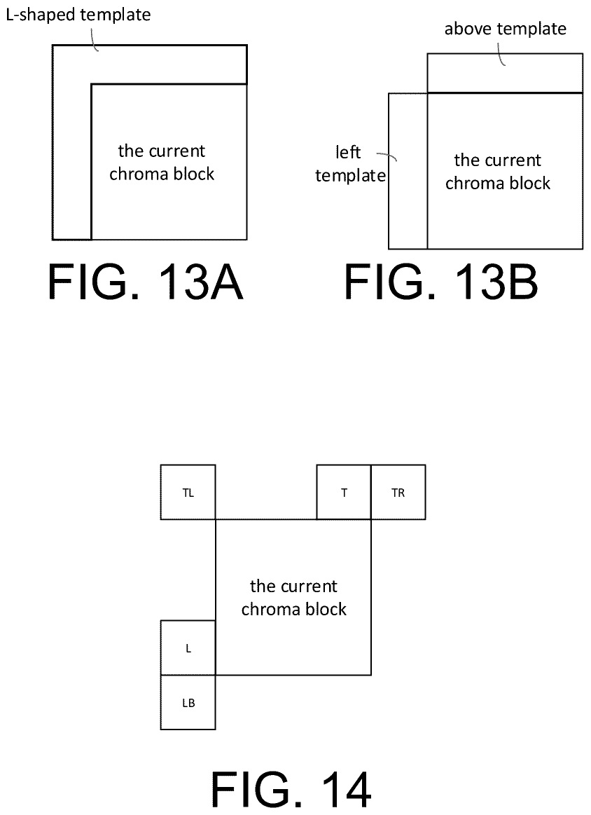

According to one example, the non-CCP modes are used to predict the template of the current chroma block by its neighboring samples. The SAD values between the predicted values and the reconstructed values of the template of the current chroma block are calculated for each non-CCP mode. Signaling order of these non-CCP modes are reordered according to SAD value from smallest to largest. The template can be an L-shaped neighboring area of the current chroma block with N lines as illustrated by FIG. 13A, or N neighboring rows and N neighbouring columns of the current chroma block as illustrated by FIG. 13B, where N can be any positive integer value. By way of example, N can be equal to 1, or 2, or 4.

According to another example, the non-CCP modes are used to predict both the collocated luma block and the template of the current chroma block. For each mode, SAD values of the collocated luma block and of the template of the current chroma block are calculated respectively. Then, the respective SAD values are averaged or weighted averaged, and the averaged SAD value is used for reordering.

By way of example, the sum of the SAD value of the collocated luma block, the SAD value of the Cb template, and the SAD value of the Cr template are summed as in Equation 9 below, yielding a template cost used for reordering:

$$cost = {SAD}_{luma} + {SAD}_{Cb} + {SAD}_{Cr}$$

where SADₗᵤₘₐ represents the SAD value of the collocated luma block, SAD_{Cb} represents the SAD value of template of the current chroma block for Cb component, and SAD_{Cr} represents the SAD value of template of the current chroma block for Cr component.

By way of another example, SADₗᵤₘₐ, SAD_{Cb}, and SAD_{Cr} are summed by weighting as in Equation 10 below, yielding a template cost used for reordering:

$$cost = a \cdot {SAD}_{luma} + b \cdot {SAD}_{Cb} + c \cdot {SAD}_{Cr}$$

where a, b and c are three factors which can be any values.

By way of another example, the Cb template and the Cr template are further subdivided to yield SAD values which are summed by weighting as in Equation 11 below, yielding a template cost used for reordering:

$$cost = a \cdot {SAD}_{luma} + b \cdot ( {SAD}_{CbTop} + {SAD}_{CrTop} ) + c \cdot ( {SAD}_{cbLef𝔱} + {SAD}_{CrLef𝔱} )$$

where SAD_{CbTop} represents the SAD value of top template of the current chroma block for Cb component, SAD_{CrTop} represents the SAD value of top template of the current chroma block for Cr component, SAD_{CbLeft} represents the SAD value of left template of the current chroma block for Cb component, and SAD_{CrLeft} represents the SAD value of left template of the current chroma block for Cr component.

By way of another example, Equation 12 below yields the template cost used for reordering:

$$cost = a \cdot {SAD}_{luma} + ( {SAD}_{CbTop} + {SAD}_{CrTop} ) << ( log H + 2 ) + ( {SAD}_{cbLef𝔱} + {SAD}_{CrLef𝔱} ) << ( log W + 2 )$$

where W and H represent the width and height of the current chroma block, respectively.

In some embodiments, one or more template cost functions are alternatively calculated. According to one example, the SATD value is calculated and used for reordering. According to another example, both SAD and SATD values are calculated and the minimum value between SATD value and 2*SAD value is used for reordering.

In some embodiments, the template cost function used for reordering is determined based on block size. According to one example, SAD values are calculated for small blocks, and SATD values are calculated for large blocks. According to another example, SATD values are calculated for small blocks, and SAD values are calculated for large blocks.

In some embodiments, the non-CCP modes to be reordered can be reduced or expanded. Reordering can be limited to only a subset of the allowed non-CCP modes in ECM, or the allowed non-CCP modes in ECM are extended before reordering. According to one example, the chroma DBV mode is not reordered; a flag is signaled to indicate whether the chroma DBV mode is selected. If the chroma DBV mode is not selected, signaling order of the other non-CCP modes is reordered. According to another example, the chroma DIMD mode is not reordered; a flag is signaled to indicate whether the chroma DIMD mode is selected. If the chroma DBV mode is not selected, signaling order of the other non-CCP modes is reordered.

According to a further example, the angular intra prediction modes from neighbouring chroma blocks can be added to the ordered list of non-CCP modes and then reordered. For a W×H chroma block at (i,j) (the width of the block is W, the height of the block is H, the position coordinates of the top left corner sample in the current frame is (i,j)), the neighboring chroma blocks include: the left block (the coding unit contains sample at (i−1,j+H−1)), the top block (the coding unit contains sample at (i+W−1,j−1)), the left bottom block (the coding unit contains sample at (i−1,j+H)), the top right block (the coding unit contains sample at (i+W,j−1)), and the top left block (the coding unit contains sample at (i−1,j−1)) as illustrated by FIG. 14.

According to a further example, the angular intra prediction modes from one or more positions within the collocated luma block can be added to the ordered list of participating non-CCP modes and then reordered. As illustrated by FIGS. 11A and 11B above, the prediction mode of block C is used as the DM mode. Thus, the prediction mode of blocks TL, TR, BL and BR can be added.

According to a further example, the angular intra prediction modes from one or more collocated reconstructed luma samples can be added to the ordered list of participating non-CCP modes, based on the histogram of gradients constructed for reconstructed luma samples of the current chroma block (from chroma DIMD mode, as described above), and then reordered. The K angular intra prediction modes for reconstructed luma samples having the largest histogram amplitude values in the histogram of the gradients can be added to the signaling order. K can be any positive integer value.

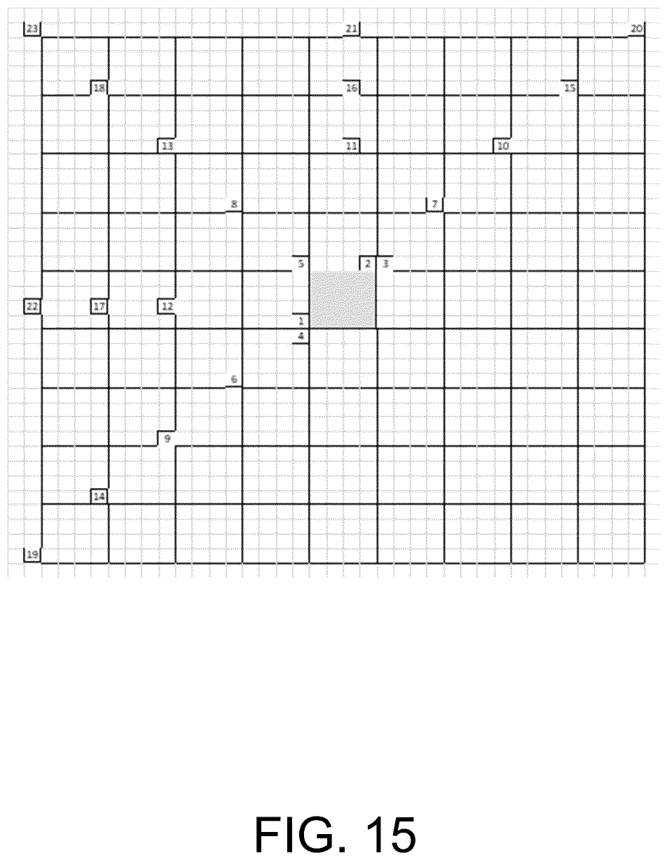

According to a further example, the angular intra prediction modes from non-adjacent chroma blocks can be added to the ordered list of participating non-CCP modes and then reordered. For example, the angular intra prediction modes from non-adjacent chroma blocks in position of “6” to “23” in FIG. 15 can be added.

According to a further example, signaling order of: the planar mode, the DC mode and the 65 angular intra prediction modes are reordered.

According to a further example, signaling order of: a subset of the planar mode, the DC mode and the 65 angular intra prediction modes are reordered.

According to a further example, one or more block vectors from the collocated luma block and neighboring chroma blocks can be added to the ordered list of participating non-CCP modes and then reordered. For example, the block vectors of 5 positions in the collocated luma block illustrated by FIGS. 11A and 11B above can be added if available. For example, the block vectors of the 5 neighboring blocks illustrated by FIG. 14 above can be added if available. If a position in the collocated block or a neighboring chroma block is coded by a bi-predictive IBC mode, both the block vectors can be added.

In some embodiments, a pruning method is performed on the ordered list of participating non-CCP modes to ensure that the non-CCP modes participating in the reordering are not duplicated. For planar mode, DC mode and angular intra prediction modes, the mode index should be different. For example, the DM mode, the chroma DIMD mode, the four default intra prediction modes and the angular intra prediction modes of neighboring chroma blocks are to be reordered. If an angular intra prediction mode of a neighboring chroma block is the same as one of the DM mode, the chroma DIMD mode and the four default intra prediction modes, it is not added to be reordered. For block vector based modes, the block vector should be different.

According to further embodiments, the pruning method is further extended to ensure that the non-CCP modes participating in the reordering are not similar. For example, the DM mode, the chroma DIMD mode and the four default intra prediction modes are added to the ordered list of participating non-CCP modes first. Then, each respective mode among the angular intra prediction modes associated with collocated luma blocks and the angular intra prediction modes of neighboring chroma blocks are further added to the ordered list of participating non-CCP modes one by one, for each mode where differences between its mode index and the respective mode indices of each mode of the ordered list are larger than a threshold.

In some embodiments, the template cost used for reordering is calculated based on the occurrence frequency of each mode in the ordered list of participating non-CCP modes. For example, the template cost can be downweighted proportionally to the frequency of each mode occurring in the ordered list: the DM mode, the chroma DIMD mode, the four default intra prediction modes, the angular intra prediction modes associated with collocated luma blocks and the angular intra prediction modes of neighboring chroma blocks are added to the ordered list and the number of occurrences of each mode in the ordered list are calculated. Then, the template cost for each mode is calculated, and is then multiplied by a factor based on the number of occurrences of the mode. Finally, the modes in the ordered list are reordered according to the template cost which are multiplied by the factors. In one example, this factor is equal to 0.9 raised to the n-th power, where n is the number of occurrences of a specific mode.

In some embodiments, P modes are input for reordering and only a subset of top Q modes with least template cost are output. The Q modes can be used to predict the current chroma block. P and Q can be any positive integer value and Q should less than or equal to P.

According to one example, the DM mode, the chroma DIMD mode, the four default intra prediction modes, the angular intra prediction modes of neighboring chroma blocks and the modes from one or more positions within the collocated luma block with pruning are added to the ordered list of participating non-CCP modes for reordering, and the 6 modes with least template cost after reordering the ordered list are output.

According to another example, the chroma DBV mode, the DM mode, the chroma DIMD mode, the four default intra prediction modes, the angular intra prediction modes of neighboring chroma blocks, the modes from multiple positions within the collocated luma block, and the block vectors from multiple positions within the collocated luma block with pruning are added to the ordered list of participating non-CCP modes for reordering; after reordering the ordered list, the 7 modes having least template cost are output.

According to a further example, the value of Q is determined by whether there is an available block vector from the collocated block. For example, the chroma DBV mode, the DM mode, the chroma DIMD mode, the four default intra prediction modes, the angular intra prediction modes of neighboring chroma blocks, the modes from multiple positions within the collocated luma block, and the block vectors from multiple positions within the collocated luma block with pruning are added to the ordered list of participating non-CCP modes for reordering; after reordering the ordered list, the 7 modes having least template cost are output when there is at least one available block vector from the collocated block, or the 6 modes having least template cost are output when there is no available block vector from the collocated block.

In some embodiments, the number of modes added to the ordered list of participating non-CCP modes used for reordering is fixed to a value P. After adding modes as provided for by the above examples and embodiments, if the number of the modes in the ordered list is still less than P, further derived modes are added until the ordered list includes P modes. The derived modes are derived by adding or subtracting an arbitrary offset value to the mode indices of the existing non-angular modes of the ordered list.

In some embodiments, the reordered list is further rearranged to have better diversity. In the rearranging process, each list element after the first is considered redundant and is moved to a later position if the template cost difference between that list element and its predecessor list element is less than a value λ: first, the minimum template cost difference between a list element and its predecessor list element among all elements in the ordered list is determined. If the minimum template cost difference is greater than or equal to λ, the list element is not moved. If this minimum template cost difference is less than λ, the list element is considered redundant, and it is moved to a later position in the ordered list. This further position is the first position where the list element is diverse enough compared to its predecessor list element. The rearranging process continues until the above steps are performed for each list element after the first.

In some embodiments, the chroma prediction mode signaling order is either reordered or not reordered based on template costs of some modes. By way of example, the template costs of the first-place mode and the second-place mode in signaling order are calculated. If the template cost of the first-place mode multiplied by a factor is less than the template cost of the second-place mode, signaling order is not reordered, and the signaling order provided by ECM is used; otherwise, the signaling order is reordered. By way of another example, if the template cost of the first-place mode is less than a threshold, the signaling order is not reordered. As shown in Table 1 above, the first-place mode in signaling order is chroma DBV mode and the second-place mode in signaling order is DM mode. Alternatively, the first-place mode is DM mode, and the second-place mode is chroma DIMD mode.

In some embodiments, the reordering process can be terminated early based on the template cost of certain modes. For example, the chroma DBV mode, the DM mode, the chroma DIMD mode and the four default intra prediction modes are added to the ordered list of participating non-CCP modes and reordered first. In one example, if the template cost of the first-place mode multiplied by a factor is less than the template cost of the second-place mode in the at least partially reordered ordered list, the reordering process is terminated; otherwise, the angular intra prediction modes associated with collocated luma blocks and the angular intra prediction modes of neighboring chroma blocks are added to the ordered list, which is further reordered. In another example, if the first-place mode in the at least partially reordered ordered list is a planar mode or DC mode, the reordering process is terminated. In another example, if the first-place mode in the at least partially reordered ordered list is chroma DBV mode, the reordering process is terminated.

In some embodiments, the chroma prediction mode signaling order is either reordered or not reordered based on block size. In one example, signaling order is not reordered for small blocks. In another example, signaling order is not reordered for large blocks.

The aforementioned embodiments can be freely combined. For example, the chroma DBV mode, the DM mode, the chroma DIMD mode, the four default intra prediction modes, the angular intra prediction modes of neighboring chroma blocks, the modes from different position of the collocated luma block and the block vectors from different position of the collocated luma block with pruning are added to an ordered list of participating non-CCP modes for reordering. The input modes are used to predict the collocated luma block and the SAD value between prediction values and the reconstructed values are calculated and used for reordering. After reordering the ordered list, the 7 modes having least template cost are output when there is at least one available block vector from the collocated block, or the 6 modes with least template cost are output when there is no available block vector from the collocated block. The output modes are signaled as shown in Table 4 above.

As mentioned above and further described below, a non-CCP mode can be fused with a CCP mode, and ECM further provides for signaling “no fusion,” a “first method,” a “second method” where the CCP mode is CCLM, and a “second method” where the CCP mode is MMLM, as four distinctly signaled chroma fusion modes. Depending on which chroma fusion mode is applied, template costs used for reordering will yield different values, and therefore reordering will yield different outcomes.

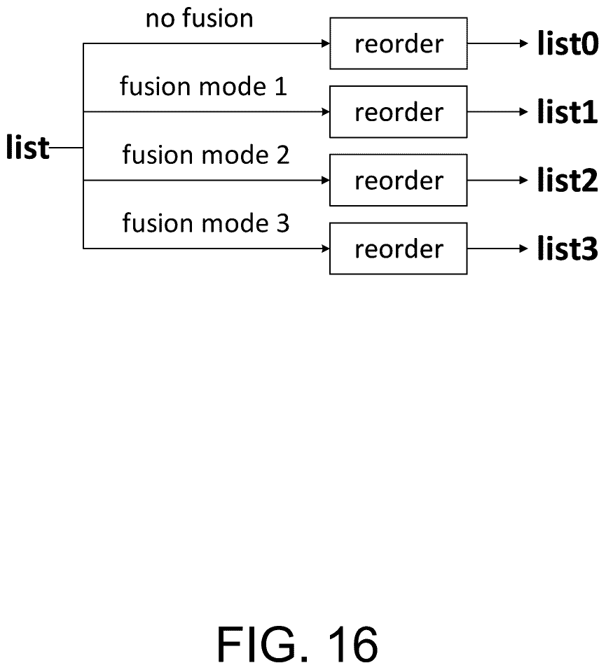

Therefore, according to example embodiments of the present disclosure, an ordered list of non-CCP modes is copied and reordered once for each respective distinctly signaled chroma fusion mode. First, an ordered list of non-CCP modes is constructed as described above. Then, for each respective distinctly signaled chroma fusion mode as described above, including “no fusion,” a copy of the ordered list is made and is reordered as illustrated by FIG. 16, where template costs for reordering are calculated for each respective fusion mode. When reordering for a fusion mode, the fusion method is applied to the chroma template to calculate the template cost.

A VVC-standard encoder and a VVC-standard decoder can be configured to explicitly signal a chroma fusion mode by a chroma fusion index. Given a signaled chroma fusion index, a VVC-standard encoder and a VVC-standard decoder configure one or more processors of a computing system to construct an ordered list of non-CCP modes as described above; respectively reorder a copy of the ordered list of non-CCP modes for each possible distinctly signaled chroma fusion mode; and, depending on which chroma fusion mode is signaled, refers to a respective reordered ordered list corresponding to the signaled chroma fusion mode.

Alternatively, a VVC-standard encoder and a VVC-standard decoder can be configured to derive the chroma fusion index without explicit signaling. Given no signaled chroma fusion index, a VVC-standard encoder and a VVC-standard decoder configure one or more processors of a computing system to construct an ordered list of non-CCP modes as described above; further add each possible fusion of a non-CCP mode with a CCP mode to the ordered list; and reorder the ordered list as described above.

According to example embodiments of the present disclosure, different prediction modes are applied to Cb and Cr components, and different ordered lists of non-CCP modes are constructed and are reordered for, respectively, a Cb block and a Cr block.

A first ordered list of non-CCP modes is constructed by adding several modes as described above and the Cb prediction modes of the neighboring blocks, and is reordered as described above based on the template cost of the chroma template for Cb component and the template cost of the collocated luma block.

A second ordered list of non-CCP modes is constructed by adding several modes as described above and the Cr prediction modes of the neighboring blocks, and reordered as described above based on the template cost of the chroma template for Cr component and the template cost of the collocated luma block.

Each list element in the two ordered lists corresponds to a chroma intra prediction mode. A VVC-standard encoder and a VVC-standard decoder are configured to signal two indices indicating which mode in the first ordered list is used to predict the Cb block and which mode in the second ordered list is used to predict the Cr block, respectively.

Alternatively, one ordered list of non-CCP modes is constructed and reordered, where each list element corresponds to a chroma intra prediction mode. A VVC-standard encoder and a VVC-standard decoder are configured to signal two indices to indicate which two modes in the list are used to predicted Cb and Cr blocks, respectively. The modes in the list are reordered as described above based on the template cost of the chroma template for both Cb and Cr components and the template cost of the collocated luma block.

Alternatively, one ordered list of non-CCP modes is constructed and reordered, where each list element corresponds to a pair of chroma intra prediction modes, in which the first one is used for Cb and the second one is used for Cr. A VVC-standard encoder and a VVC-standard decoder are configured to signal an index indicating which pair of modes in the list is used to predict Cb and Cr blocks, respectively. The pairs of modes in the list are reordered as described above based on the template cost of chroma template for both Cb and Cr components and the template cost of the collocated luma block.

According to example embodiments of the present disclosure, different non-CCP modes can be fused to predict a chroma block: the prediction blocks of two non-CCP modes are weighted-averaged to generate a final prediction block of the current chroma block.

In one example, one ordered list of non-CCP modes is constructed and reordered, where each list element corresponds to a chroma intra prediction mode. A VVC-standard encoder and a VVC-standard decoder are configured to signal two indices indicating which two modes in the list are fused to predict the current chroma block.

In another example, two ordered lists of non-CCP modes are constructed and reordered, where each element of the first ordered list corresponds to a chroma intra prediction mode, and each element of the second ordered list corresponds to two chroma intra prediction modes. A VVC-standard encoder and a VVC-standard decoder are configured to signal a flag indicating which ordered list is used, and further signal an index indicating which element in the selected ordered list is used. If the first ordered list is selected, one mode is used to predict the current chroma block. If the second ordered list is selected, two modes are fused to predict the current chroma block.

In another example, one ordered list of non-CCP modes is constructed and reordered, where each list element corresponds to one chroma intra prediction mode or a pair of chroma prediction modes. A VVC-standard encoder and a VVC-standard decoder are configured to signal an index indicating which element is selected. If the selected element corresponds to one mode, the mode is used to predict the current chroma block. If the selected element corresponds to a pair of modes, the two modes are fused to predict the current chroma block.

In another example, one ordered list of non-CCP modes is constructed and reordered, where each list element corresponds to a chroma intra prediction mode. A VVC-standard encoder and a VVC-standard decoder are configured to signal an index indicating which element is selected. If the first element is selected, the corresponding mode is used to predicted the current block. Otherwise (if the selected one is not the first element), the corresponding mode and the first mode in the list are fused to predict the current chroma block.

According to example embodiments of the present disclosure, the chroma DBV mode can be fused with a CCP mode.

In one example, the chroma DBV mode can be combined with the two chroma fusion methods. When a flip type is applied, the CCP prediction block is flipped and then fused with the chroma DBV prediction block.

In another example, the chroma DBV mode can only be combined with the first chroma fusion method. When a flip type is applied, the chroma DBV prediction block is flipped and then the CCP parameters are applied to generate a new prediction block. Finally, the new prediction block is flipped.

In some embodiments, flipping is not applied to chroma DBV mode. When a flip type is applied, the chroma DBV mode is set to not available for the current chroma block.

In ECM, the block vector is selected in the following order: {C, TL, TR, BL, BR}, and the first block vector that is available for the current chroma block is selected for chroma DBV mode.

According to example embodiments of the present disclosure, if there are more than one available block vector from the collocated luma block, the block vectors are reordered by the collocated luma block or the template of the current chroma block. The block vector with the least template cost is used for chroma DBV mode.

In some embodiments, the available block vectors from neighboring chroma blocks can also be added to the reordering.

The aforementioned embodiments can be freely combined.

Persons skilled in the art will appreciate that all of the above aspects of the present disclosure may be implemented concurrently in any combination thereof, and all aspects of the present disclosure may be implemented in combination as yet another embodiment of the present disclosure.

FIG. 17 illustrates an example system 1700 for implementing the processes and methods described above for implementing chroma intra prediction modes.

The techniques and mechanisms described herein may be implemented by multiple instances of the system 1700 as well as by any other computing device, system, and/or environment. The system 1700 shown in FIG. 17 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 1700 may include one or more processors 1702 and system memory 1704 communicatively coupled to the processor(s) 1702. The processor(s) 1702 may execute one or more modules and/or processes to cause the processor(s) 1702 to perform a variety of functions. In some embodiments, the processor(s) 1702 may include a central processing unit (“CPU”), a graphics processing unit (“GPU”), both CPU and GPU, or other processing units or components known in the art. Additionally, each of the processor(s) 1702 may possess its own local memory, which also may store program modules, program data, and/or one or more operating systems.

Depending on the exact configuration and type of the system 1700, the system memory 1704 may be volatile, such as RAM, non-volatile, such as ROM, flash memory, miniature hard drive, memory card, and the like, or some combination thereof. The system memory 1704 may include one or more computer-executable modules 1706 that are executable by the processor(s) 1702.

The modules 1706 may include, but are not limited to, one or more of an encoder 1708 and a decoder 1710.

The encoder 1708 may be a VVC-standard encoder implementing any, some, or all aspects of example embodiments of the present disclosure as described above, and executable by the processor(s) 1702 to configure the processor(s) 1702 to perform operations as described above.

The decoder 1710 may be a VVC-standard decoder implementing any, some, or all aspects of example embodiments of the present disclosure as described above, executable by the processor(s) 1702 to configure the processor(s) 1702 to perform operations as described above.

The system 1700 may additionally include an input/output (“I/O”) interface 1740 for receiving image source data and bitstream data, and for outputting reconstructed pictures into a reference picture buffer or DPB and/or a display buffer. The system 1700 may also include a communication module 1750 allowing the system 1700 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium 1730, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient or non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transient or non-transitory computer-readable storage media that, when executed by one or more processors, may perform operations described above with reference to FIGS. 1A-16. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
constructing an ordered list comprising, in signaling order, a plurality of non-CCP modes participating in predicting a template of a current chroma block; and
reordering the ordered list based on respective template costs of each non-CCP mode.

2. The computing system of claim 1, wherein the operations further comprise:
predicting the template and predicting the current chroma block based on a same non-CCP mode.

3. The computing system of claim 1, wherein the template of the current chroma block comprises luma samples of a collocated luma block of the current chroma block.

4. The computing system of claim 1 the template of the current chroma block comprises neighboring samples of the current chroma block.

5. The computing system of claim 1, wherein the template of the current chroma block comprises luma samples of a collocated luma block of the current chroma block and neighboring chroma samples of the current chroma block.

6. The computing system of claim 1, wherein an earliest-ordered non-CCP mode is transmitted using fewer bits in a bitstream than a latest-ordered non-CCP mode.

7. The computing system of claim 1, wherein a template cost of a non-CCP mode comprises a weighted sum of respective template cost function outputs of the collocated luma template, a Cb template of the current chroma block, and a Cr template of the current chroma block.

8. The computing system of claim 1, wherein a template cost of a non-CCP mode comprises a weighted sum of respective template cost function outputs of the collocated luma template, a top Cb template and a top Cr template of the current chroma block, and a left Cb template and a left Cr template of the current chroma block.

9. The computing system of claim 1, wherein the ordered list further comprises an angular intra prediction mode of a neighboring chroma block.

10. The computing system of claim 9, wherein the angular intra prediction mode does not comprise any of: planar mode, DC mode, and four default intra prediction modes.

11. The computing system of claim 1, wherein the ordered list further comprises an angular intra prediction mode of a position within the collocated luma block.

12. The computing system of claim 1, wherein the ordered list further comprises an angular intra prediction mode associated with a collocated reconstructed luma sample of the current chroma block, based on a histogram of gradients constructed for collocated reconstructed luma samples.

13. The computing system of claim 1, wherein the ordered list further comprises at least a subset of: planar mode, DC mode, and 65 angular intra prediction modes.

14. The computing system of claim 1, wherein the ordered list further comprises at least one of: a block vector of the collocated luma block, and a block vector of a neighboring chroma block.

15. The computing system of claim 1, wherein the operations further comprise outputting a subset of non-CCP modes having least template cost after reordering.

16. The computing system of claim 1, wherein the ordered list further comprises a non-CCP mode derived by adding an offset value to a mode index of a non-angular mode of the ordered list.

17. The computing system of claim 1, wherein reordering the ordered list comprises moving a non-CCP mode to a later position until a template cost difference between the non-CCP mode and a predecessor list element is greater than or equal to a threshold value.

18. The computing system of claim 1, wherein reordering the ordered list is performed based on a template cost of a first-place non-CCP mode being equal to or greater than a second-place non-CCP mode in signaling order.

19. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
fusing a chroma DBV prediction block with a flipped CCP prediction block, or applying CCP prediction parameters to a flipped chroma DBV prediction block.

20. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
selecting a block vector having least template cost for chroma DBV mode.
